(19) United States
(12) Patent Application Publication
(10) Pub. No.: US 2013/0103889 A1
(43) Pub. Date: Apr. 25, 2013

(54) PAGE-BUFFER MANAGEMENT OF NON-VOLATILE MEMORY-BASED MASS STORAGE DEVICES

(71) Applicant: Soogil Jeong, Pleasanton, CA (US)

(72) Inventor: Soogil Jeong, Pleasanton, CA (US)

(73) Assignee: OCZ TECHNOLOGY GROUP INC., San Jose, CA (US)

(21) Appl. No.: 13/280,597

(22) Filed: Oct. 25, 2011

(51) Int. Cl. G06F 12/00

(52) U.S. Cl. 711/103; 711/E12.008

(57) ABSTRACT

Mass storage devices and methods that use at least one non-volatile solid-state memory device, for example, one or more NAND flash memory devices, that defines a memory space for permanent storage of data. The mass storage device is adapted to be operatively connected to a host computer system having an operating system and a file system. The memory device includes memory cells organized in pages that are organized into memory blocks for storing data, and a page buffer partitioned into segments corresponding to a cluster size of the operating system or the file system of the host computer system. The size of a segment of the page buffer is larger than the size of any page of the memory device. The page buffer enables logically reordering multiple clusters of data fetched into the segments from pages of memory device and write-combining segments containing valid clusters.

### BACKGROUND OF THE INVENTION

The present invention generally relates to memory devices for use with computers and other processing apparatuses. More particularly, this invention relates to non-volatile (permanent) memory-based mass storage devices that use flash memory devices or any similar non-volatile solid-state memory devices for permanent storage of data.

Mass storage devices such as advanced technology (ATA) or small computer system interface (SCSI) drives are rapidly adopting non-volatile solid-state memory technology such as flash memory or other emerging solid-state memory technology, including phase change memory (PCM), resistive random access memory (RRAM), magnetoresistive random access memory (MRAM), ferromagnetic random access memory (FRAM), organic memories, and nanotechnology-based storage media such as carbon nanofiber/nanotube-based substrates. Currently the most common technology uses NAND flash memory devices as inexpensive storage memory.

NAND flash memory devices (integrated circuits, or ICs) store information in an array of floating-gate transistors (FGTs), referred to as cells. NAND flash cells are organized in what are commonly referred to as pages, which in turn are organized in predetermined sections of the component referred to as blocks. Each block is the minimum erasable physical data structure of the NAND flash memory space, and the pages of each block are the minimum read and write units. The page size of flash memory has evolved from 512 Bytes to 4 kBytes (kB) and recently to 8 kBytes, with future generations of NAND flash memory devices expected to reach 16 or 32 kBytes page sizes. Although it is possible to perform sub-page reads and writes (programming of NAND flash cells), the most commonly used practice for a read-modify-write operation involves reading out the entire page into the page buffer of the flash memory device and then writing the entire page back to either a different page on the same block or a free page on a different block. The page buffer can be SRAM-based or a register.

NAND flash memory is increasingly gaining importance as a storage media in mass storage devices such as solid state drives (SSDs) used in computer systems. Current file systems use 4 Kbytes cluster sizes as the smallest allocation unit associated with the file system used by the operating system of a computer. Each cluster comprises a contiguous number of physical sectors wherein each sector is associated with a logical block address (LBA). A typical sector size in the case of hard disk drive technology is 512 Bytes plus parity information. However, some hard disk drives are migrating to a 4 Kbyte sector size, in which case the physical sector size equals the logical cluster size.

A similar situation exists in the case of NAND flash memory. The controller of an SSD that contains NAND flash memory devices includes a flash translation layer (FTL) that generates the physical addresses for mapping units that can correspond to LBAs, clusters or, at least in theory, to any other unit size. As long as the sector or page size on the storage media equals the cluster size of the operating system, a 1:1 ratio between cluster size on the level of the file system and the page size as the physical memory structure is maintained. Accordingly, for each given cluster that is modified, a single page needs to be re-written. The same ratio is achieved in the case of smaller page or sector sizes by consolidating a contiguous number of sectors or pages. Vice versa, rewriting an entire page to reflect a single modified cluster content does not result in redundant or superfluous re-writing of clusters that have not been modified.

The above discussed balance between the file system and the NAND memory architecture, specifically, the page size, is disrupted with the migration to smaller process geometries and the concurrent increase to page sizes that are a multiple of the file system's cluster or allocation unit size. The problem arises if a single cluster is modified, since each write access will always program an entire page. In other words, as soon as the page size increases to a multiple of the cluster size, the update of a single cluster is no longer a seamless 1:1 match between the updated data set and the physical amount of data that need to be written. Rather, even if only a single cluster is updated, a full page containing several clusters needs to be written.

Strictly speaking, it is not necessarily the cluster or allocation unit size that can generate the above-noted problem, but rather the difference between a physical “mapping unit” corresponding to the cluster or allocation unit generated by the FTL and the page size implemented in the various NAND flash devices. However, as a non-limiting example for illustrating the problem and possible solutions, the mapping unit will be considered equivalent to a cluster.

Even when using large pages spanning several clusters, it is possible to write one single cluster to another page. In this case, it is common practice to combine data to be written with other data through the process of write combining. The original file or cluster will be invalidated within its original page on the level of the file system since the pointer now points to a different physical address. However, for the original page, the result will be invalid clusters within a page containing other clusters that are still valid. In other words, any such page contains a heterogeneous mixture of valid and invalid data. However, it is important to understand that, at present, on the NAND flash device level the entire page can only be treated as a single unit without differentiating between valid and invalid data.

The above discussed problem becomes important in the context of performing write amplification and garbage collection in an efficient manner and without involving a host computer system. Specifically, garbage collection works by consolidating valid pages into fully utilized blocks through rewriting the data to spare blocks. In the process, the original pages are rendered invalid on the level of the file system. Once a block contains only pages with data that are flagged by the file system as invalid, it can be erased through a TRIM command.

It is understood that consolidation of pages containing multiple clusters, and the majority of them being invalid, will result in very poor utilization of the actual capacity of the drive in that in the extreme case only a single cluster of all clusters in a page will have valid data. For example, two pages with a capacity of four clusters but each having only a single valid cluster could be consolidated to a third page storing two valid clusters, thereby utilizing only 50% of the page's capacity for valid data. Currently used strategies can solve this problem by loading the data into the controller, buffering them in some form of cache and subsequently discarding invalid data while combining or “packing” valid page fragments to coherent full pages that are then written back to the array.

The drawback of the above discussed solution is that any data traffic involving more than a single monolithic IC will waste precious bandwidth in that, for example, an entire channel of a controller is occupied whenever the above described consolidation of valid data and discarding invalid data occurs.

In light of the above, it is apparent that new strategies are necessary to add further capabilities to the NAND flash device proper, and particularly for the purpose of enabling the memory device itself to address the mismatch between clusters on the level of the file system and physical page size on the level of the NAND flash device, without occupying and involving other ICs or logic.

For the purpose of disambiguation, the following definitions will be used in this disclosure:

Page size: the size of a page within a NAND flash memory device.

Erase block: a block of NAND flash memory that comprises a plurality of NAND flash pages and is the minimum erasable unit in a NAND flash memory device.

Cluster: the smallest number of contiguous LBAs allocated by a host computer system and equivalent to a file system allocation unit or an FTL mapping unit.

Sector: the smallest physical storage area associated with an LBA; several contiguous sectors form a cluster.

Page buffer: A small amount of SRAM or a register used to buffer the contents of a page of NAND flash.

Page buffer segment: a segment of a page buffer corresponding to a cluster containing several contiguous sectors.

Programmable page buffer segment size: variable size of page buffer segments that is programmed during initialization of a NAND flash device.

### BRIEF DESCRIPTION OF THE INVENTION

The present invention provides a non-volatile memory-based mass storage device, for example, a solid-state drive (SSD), that uses at least one non-volatile solid-state memory device, for example, one or more NAND flash memory devices, that defines a memory space for permanent storage of data, and to methods of using such a mass storage device and memory device.

According to a first aspect of the invention, a memory device is used in a mass storage device that is operatively connected to a host computer system having an operating system and a file system. The memory device includes memory cells organized in pages that are organized into memory blocks for storing data, and a page buffer partitioned into segments corresponding to a cluster size of the operating system or the file system of the host computer system. The size of the page buffer is larger than the size of any page of the memory device.

According to a preferred aspect of the invention, the memory device is a NAND flash memory device, the page buffer is a multiple of a page size of the memory device, and segment sizes within the page buffer may be programmed during initialization of the memory device in order to increase access speed and provide flexibility for use in multiple environments and operating systems.

According to another aspect of the invention, the memory device is a NAND flash memory device, and the page buffer is partitioned into segments corresponding to the cluster size of the file system used by the host computer system. A first page containing a mixture of valid and invalid clusters is read into the page buffer and the clusters are associated with or stored in the segments. The segments containing invalidated clusters are marked for purging. A second page is read into the page buffer and segments containing invalid clusters are marked for purging. Segments containing valid data from both of the first and second pages are re-ordered, consolidated to correspond to a full page, aligned with the page boundaries of the memory device, and written to a third page of the memory device. Overflow segments, that is, valid segments exceeding the number of available segment capacity in a page, are carried over to be combined with segments corresponding to valid clusters from a fourth page read into the page buffer on a subsequent page read access, and written back to a fifth page as soon as the combined segments correspond to a page size.

According to a yet another aspect of the invention, data from at least two pages of a memory block of the memory device are read to the page buffer and segments containing invalid clusters are purged. The valid segments are reordered, consolidated and aligned to page boundaries. The aligned valid segments are written to a third page of the memory. Overflow segments are combined with segments containing valid sectors from a fourth page and written to a fifth page within the same or a different memory block. The first, second and fourth pages are marked as invalid. Once all free pages of the memory block are used up, all valid pages are copied to a new memory block of the memory device. Usage of a new block can also start during consolidation of partially valid pages, for example, the fifth page may be written to a different block than the third page.

Other aspects of the invention include methods for reclaiming pages of a memory device that have a capacity of multiple clusters after individual sectors stored in the pages are invalidated. Each page can store a plurality of clusters. The page buffer of the memory device can buffer multiple pages within segments corresponding to individual clusters. A first page of the memory device containing invalid clusters is read into the page buffer and the invalid sectors are purged. A second page of the memory device containing additional valid and invalid clusters is read into the page buffer and the invalid clusters are purged. Segments of the page buffer containing valid clusters of the first and second pages are combined, aligned with page boundaries of a third page of the memory device, and written to the third page. If the number of segments to be combined exceeds the number of clusters that can be stored in a page of the memory device, the overflow segments are combined with additional valid segments from a fourth page and written to a fifth page of the memory device.

Still other aspects of the invention encompass the use of a page buffer for a memory device, in which the page buffer has a capacity that is a multiple of the page size of the memory device. The page buffer is n-way set associative according to the number of clusters that can be stored in segments of the page buffer. The size of the segments can be programmed during initialization of the memory device depending on operational parameters of the host computer system's basic input/output system (BIOS), the extended system configuration data (ESCD), desktop management interface (DMI) or the file system used by the operating system of the host computer system. The page buffer is further configured to intelligently order logically coherent segments containing clusters from a first and a second page to write them to a third page of the memory device. Left-over segments are carried over for combining them with additional modified segments from a second page of the memory device and writing them to a third page of the memory device after reaching a page size of the combined segments or after a time-out period has been exceeded.

Another aspect of the invention involves operating the host computer system to write a single cluster of data to the mass storage device where it is committed to the memory device. The page buffer holds the cluster in one of the segments thereof and writes the data to the memory cells after enough free page buffer segments sufficient to fill an entire page of the memory device have been filled with additional writes from the host computer system or data originating in garbage collection of the mass storage device. In case the system is powered down, the page buffer is flushed and the data are committed to the memory cells even if they do not fill an entire page. Similarly after periods of inactivity that can be specified using a time-out counter, the data can be committed to the memory cells of the memory device.

Other aspects and advantages of this invention will be better appreciated from the following detailed description.

### BRIEF DESCRIPTION OF THE DRAWINGS

FIG. 1 shows the typical organization of a 4 Gbit NAND flash memory device (IC) having 128 pages of 4 kB page size including input/output (I/O), address, control, voltage generation, error checking and correction (ECC) capacity and wear-leveling information logic.

FIG. 2 shows a 512 kB (4096 kbit+128 kbit ECC) NAND flash memory block with a 4 kB page size and a 4 kB page buffer in accordance with an embodiment of the invention.

FIG. 3 shows a 1 MB (8192 kbit+ECC) NAND flash memory block with an 8 kB page size capable of buffering two 4 kB clusters in an 8 kB page buffer with two segments in accordance with an embodiment of the invention.

FIG. 4 shows a 2 MB (16384 kbit+ECC) NAND flash memory block with a 16 kB page size capable of storing 4 clusters per page and a 16 kB page buffer with four 4 kB segments in accordance with an embodiment of the invention.

FIG. 5 shows a 2 MB (16384 kbit+ECC) NAND flash memory block with 16 kB page size and a 16 kB, 4-way set-associative page buffer having four 4 kB segments in accordance with an embodiment of the invention.

FIG. 6 shows a 4 MB (32 Mbit+ECC) NAND flash memory block with 32 kB page size and a 32 kB, 8-way set-associative page buffer having eight 4 kB segments in accordance with an embodiment of the invention.

FIG. 7 shows a 2 Mb NAND flash memory block with 16 kB page size and a 32 kB, 8-way set-associative page buffer having eight 4 kB segments and capable of buffering two pages in accordance with an embodiment of the invention.

FIG. 8a shows a 4 MB NAND flash memory block with 16 kB page size and 32 kB, 8-way set-associative page buffer having eight 4 kB segments fetching two pages containing valid and invalid clusters in accordance with an embodiment of the invention.

FIG. 8b shows the same block as FIG. 8a with the page buffer containing mixed contents of two pages and writing back the valid clusters from segments S0, S1, S5 and S7 to a free page, thereby utilizing the full capacity of the page in accordance with an embodiment of the invention.

FIG. 8c shows the same block as FIGS. 8a and 8b wherein, after writing the valid data back to a consolidated page, all data in the pages of origin are flagged invalid.

FIG. 9 shows a similar situation as FIGS. 8a through 8c, but with a total of five valid clusters being buffered in five segments and one of the segments carried over to be combined with additional segments on a subsequent page access.

### DETAILED DESCRIPTION OF THE INVENTION

Though the present invention is generally directed to non-volatile memory-based mass storage devices, for example, solid-state drives (SSDs), that are capable of using a variety of non-volatile solid-state memory devices, the following discussion will refer specifically to mass storage devices that make use of NAND flash memory devices, in part because NAND flash memory is a non volatile memory at extremely low cost per Byte, which makes it extremely suitable for use in mass storage devices.

The internal architecture of NAND flash memory devices causes a few functional idiosyncrasies, for example, data always are written and read in the form of entire pages, a plurality of which forms a block, which in turn is the smallest functional unit for erasing data. For the purpose of the current invention, the organization of NAND flash memory devices into pages as the smallest functional unit for read and write accesses is particularly relevant.

Most modern file systems use a uniform size of the smallest data unit associated with the operating system of a host computer system. In the case of Microsoft® Windows NTFS, this smallest data unit is 4 kBytes. Hard disk drives, which are still the prevailing storage media, are typically configured into physical sectors of 512 Bytes. However, the 4 Kbytes data equivalent is maintained by forming contiguous clusters of sectors. In other words, data management is uncomplicated as long as the smallest accessible physical data carrier is smaller than, or equal to, the smallest data unit associated with the file system. In the case of NAND flash-based storage devices, the flash translation layer generates mapping units that are the physical equivalent of the cluster used by the file system. As a result, each cluster of the file system is stored in one mapping unit generated by the FTL.

The situation becomes more complicated if the file system cluster size or the size of the mapping unit is smaller than a physical sector size, which, as discussed above, is the smallest data structure assigned to an LBA or, by extension, accessible by a read or write process. In this case it is necessary to combine multiple clusters in order to fully utilize the capacity of the sector. In the case of NAND flash, it is not sectors but pages that are the smallest functional units for a single read or program (write) access.

As discussed earlier, the page size of NAND flash memory is increasing along with the transition to smaller process geometries. The latest generations of NAND flash already features 8 Kbytes pages, meaning that every page will span two FTL mapping units and hold two 4 Kbytes file system clusters or allocation units. In the near future, the page size is expected to further increase to 16 kBytes or 32 kBytes and, accordingly, each page will be capable of storing four or eight clusters.

In most cases, this will not become an immediate problem since modern controllers as used for example in solid state drivers are capable of deferred writes and write combining, thereby combining four of eight clusters before writing them to any page in the NAND flash memory array. There is, however, the possibility that a single cluster write may occur, which would leave a page under-utilized.

Likewise, during garbage collection, pages containing a mixture of valid and invalid clusters may allow reclaiming of invalid clusters by reading the entire page into the controller and, on the controller level, recombining valid clusters from different pages while discarding the invalid data from the pages.

Either one of the above situations involves data transfer from the NAND flash IC to the controller, which means that unnecessary bandwidth is wasted. The current invention targets this issue by adding data management capabilities to the NAND flash IC in order to be able to carry out write-combining and house-keeping function internally without the involvement of any other control logic.

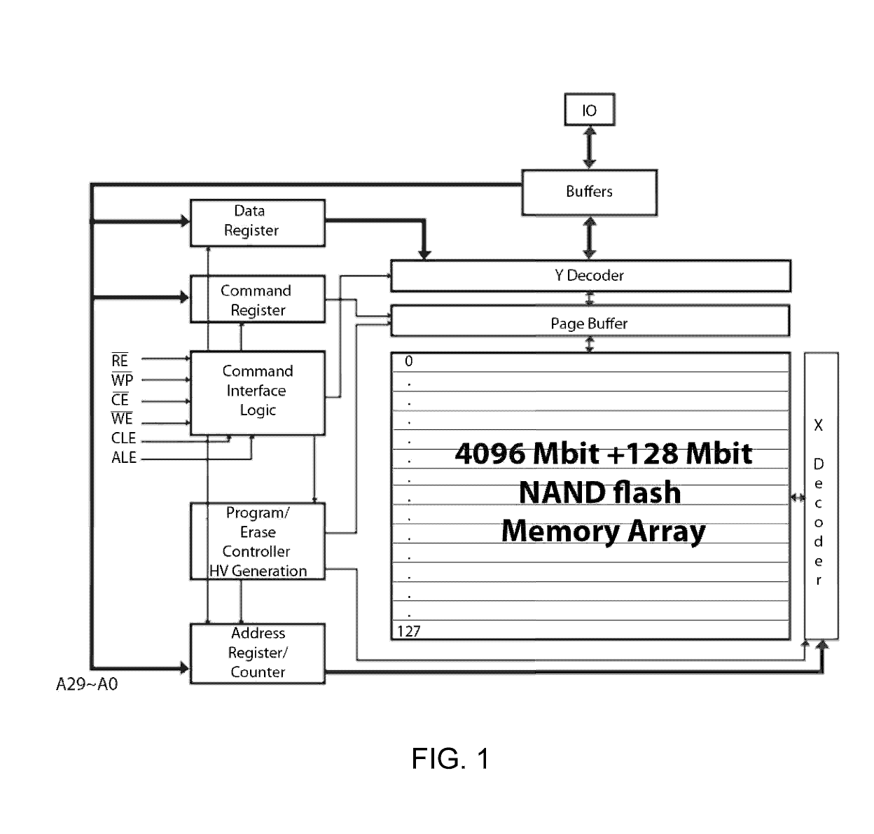

As shown in FIG. 1, a typical NAND flash IC comprises the NAND flash memory array, a page buffer, address decoders (X and Y decoders), and control decode logic along with high voltage (typically 10-20V) generators (program/erase controller HV generation) necessary to perform program and erase functions. In addition, for the purpose of housekeeping and wear leveling address registers/counters are implemented. The NAND flash IC is connected with a host computer system through an I/O-interface.

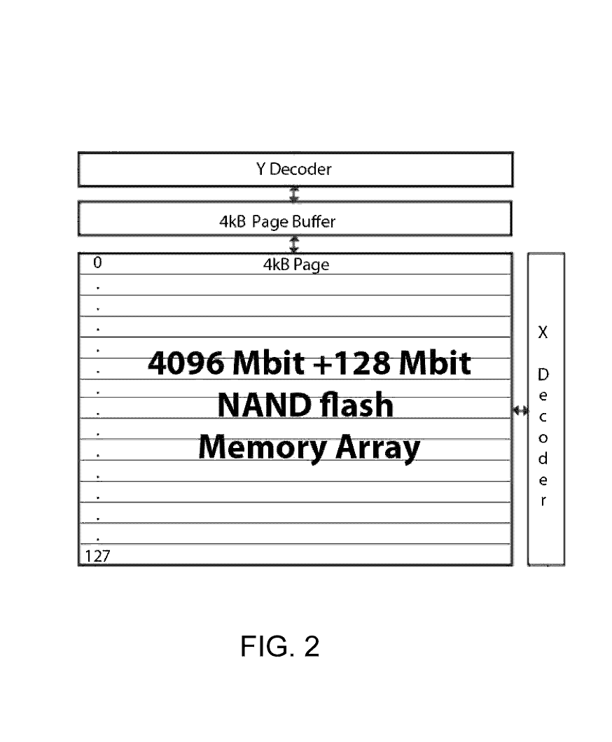

FIG. 2 is an isolated view of a block of the NAND flash array from FIG. 1, consisting of 128 pages of 4 kBytes for a total density of 4096 kbit (512 Kbytes) plus parity storage (128 kbit) and a 4 Kbytes page buffer. The page buffer matches the size of the NAND flash pages.

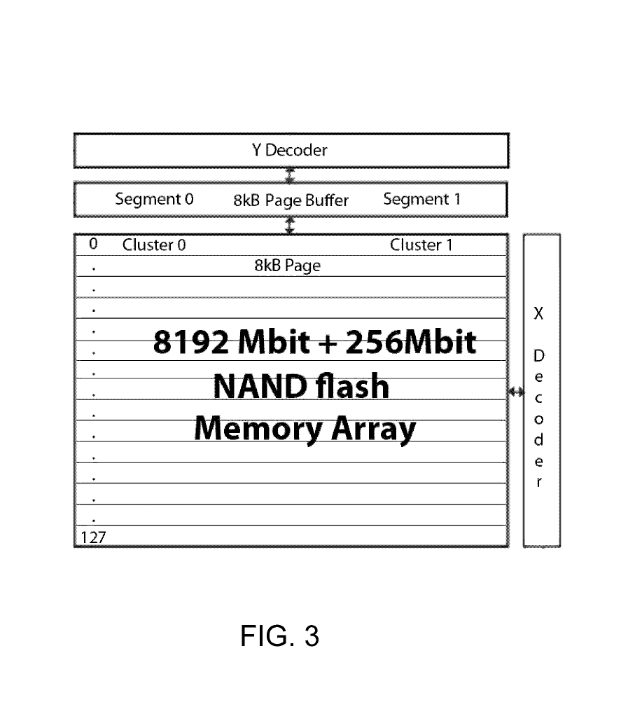

Newer generations of NAND flash use 8 Kbytes page sizes, as represented by of the block of NAND memory shown FIG. 3. In this case the page buffer, which matches the page size is also 8 kBytes. However, the cluster size of the file system is still 4 kBytes, meaning that every page stores two clusters. Pages are typically loaded in their entirety into the page buffer, therefore, the transfer cannot distinguish between valid and invalid clusters.

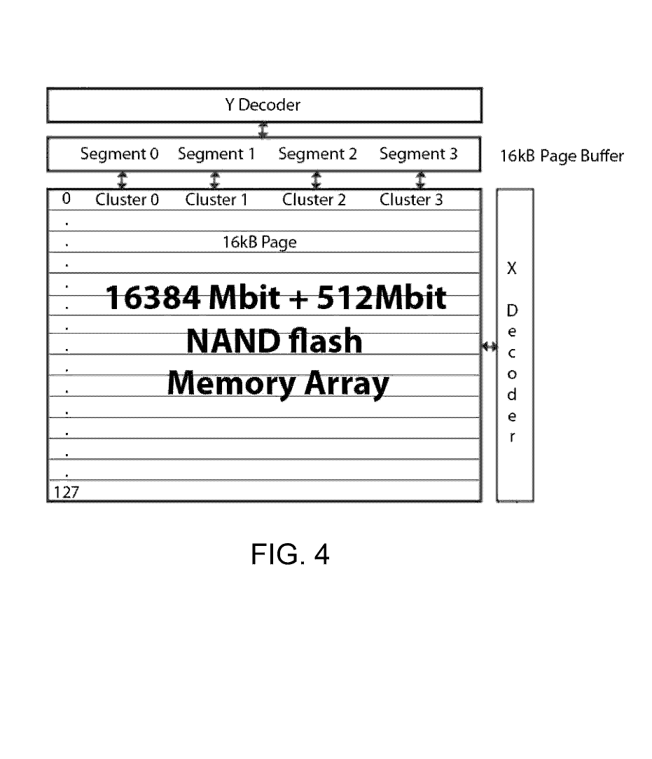

The next increment in page size results in a 16 Kbytes page size or an aggregate capacity of four clusters and the currently used full-page transfer mode results in all four clusters being loaded in a single transfer into the page buffer. For alignment purposes, the page buffer may be segmented as shown in FIG. 4.

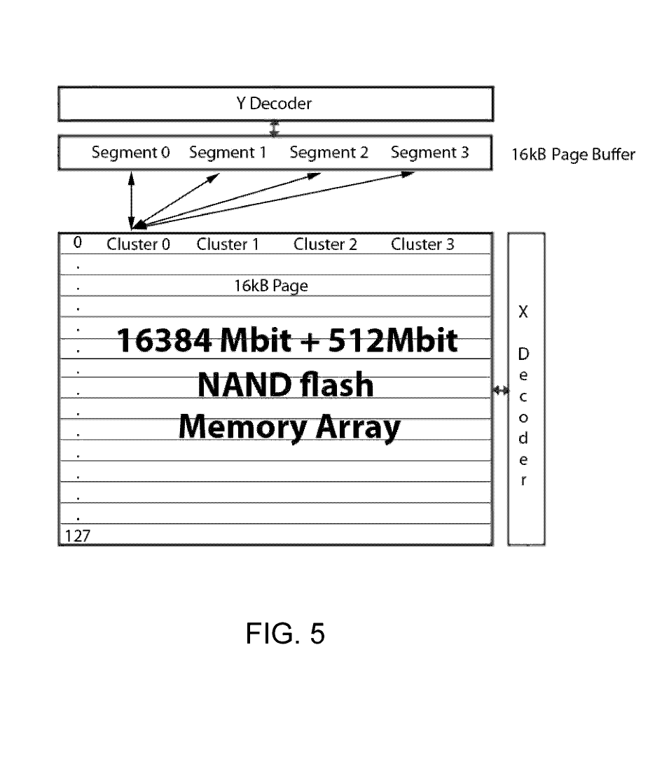

FIG. 5 shows one aspect of the invention in which the page buffer is configured as a cache. Specifically, the page buffer is set-associative to allow each cluster to be read into any segment of the page buffer. More importantly any segment can be written back from the page buffer into any location on the page. This allows re-ordering of clusters during fetching of the page or reordering of valid segments as a manner of writing them back to the NAND flash memory.

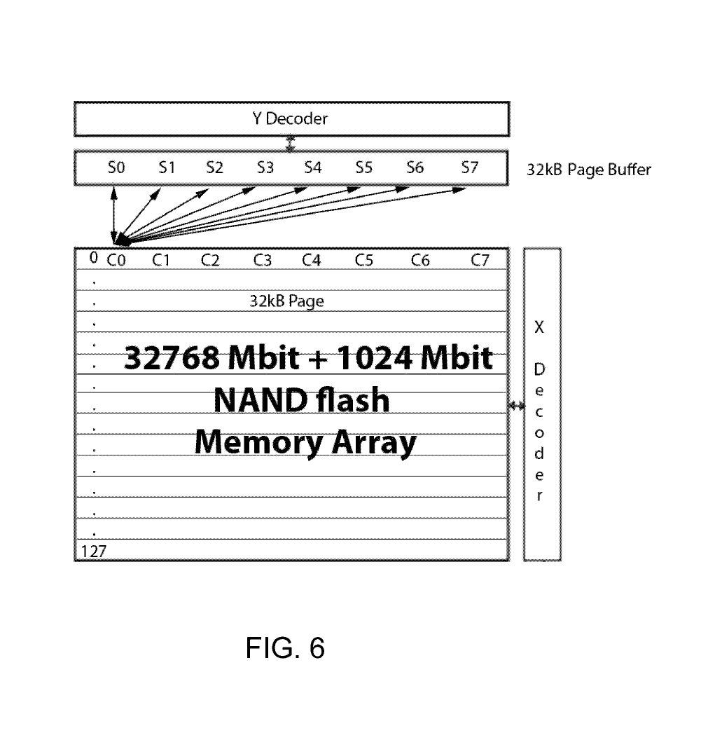

As shown in FIG. 6, the page size and the page buffer size can increase beyond 16 kBytes in which case the degree of set-associativity will increase according to the number of clusters stored in one page.

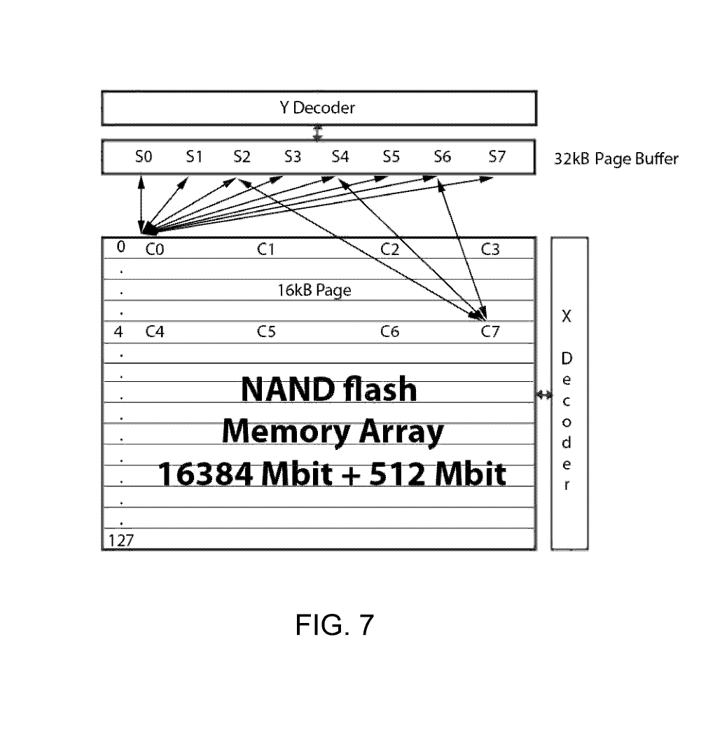

FIG. 7 shows a second aspect of the invention in which the page buffer size is twice that of a page of the NAND flash memory. In the particular example shown, the page buffer size is 32 kBytes and divided in eight segments with an eight way set-associative addressing. The page size of the NAND flash memory is 16 kBytes, consequently, all four clusters of two pages can be loaded into the page buffer and then written back to the NAND flash memory in any desired order.

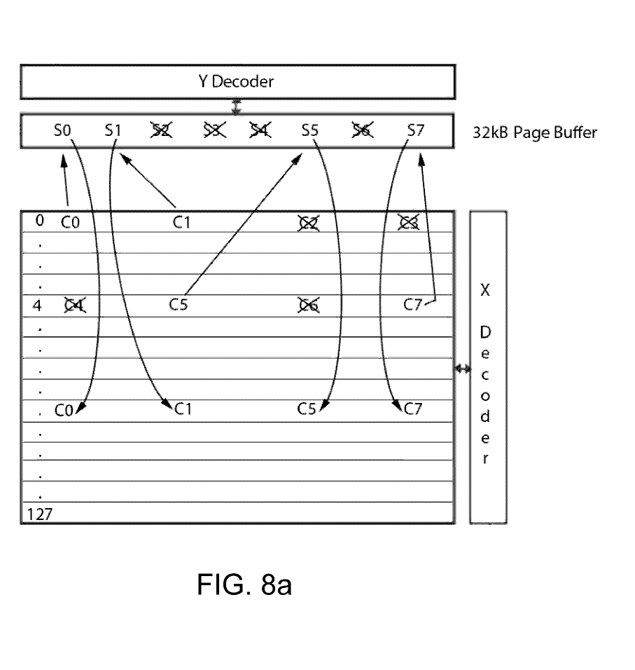

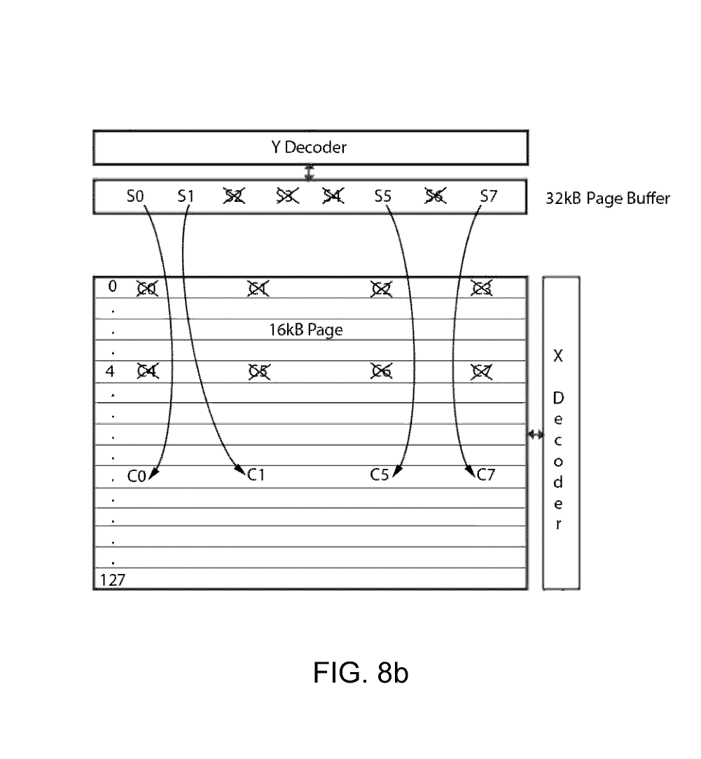

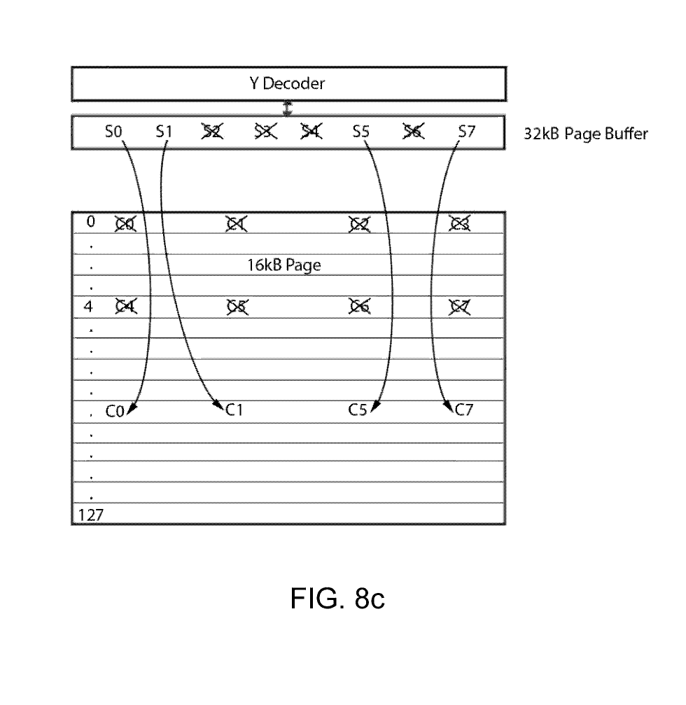

FIG. 8 shows a sequence of recombining valid clusters of two different pages wherein the invalid clusters are discarded and only the valid clusters are written back in a re-ordered sequence to the NAND flash memory. In FIG. 8a, pages 0 and 4 are read into the page buffer wherein clusters C0, C1, C5 and C7 are valid, whereas C2, C3, C4 and C6 are invalidated by the file system (shown as crossed out). FIG. 8b shows that only the valid segment (S0, S1, S5 and S6) containing valid clusters (C0, C1, C5 and C7) are written back to the first available page in the block, whereas data in segments S2, S3, S4 and S6 are discarded. Alternatively, it would be possible to only read the valid clusters to the page buffer through allowing partial page reads. As shown in FIG. 8c, after the valid data have been stored in a free page of the NAND flash memory, all data in the original pages are invalidated.

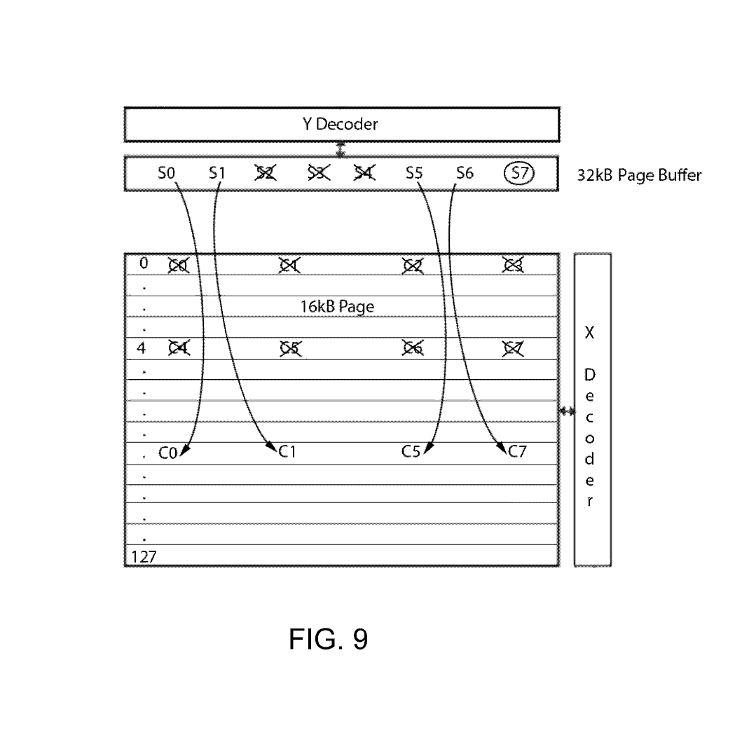

If the number of valid clusters from two pages exceeds the capacity of a single page, the page buffer can hold the valid segment and carry it over to the next cycle in order to coalesce it with data from additional pages, align the valid data to page boundaries and then write them back to a free page. FIG. 9 shows such a left-over segment after buffering of two pages resulted in 5 valid segments.

### New Nand Flash Instructions

To facilitate the proposed structure and operation, it would be advantageous to add several new NAND flash commands to the existing instruction or command set. Possible command extensions are given below as illustrative, non-limiting examples:

1. An extension to existing commands like read, program, copyback
a. Read/Copyback read
   Existing command format: {1^{st} command, column addr, raw addr, 2^{nd} command, data read}
   New command format: {1^{st} command, column addr, raw addr, buffer offset, xfer size, 2^{nd} command, data read}
   Buffer offset, xfer size: 2 bytes
      Command encoding may vary depending on the specific NAND flash IC used. However, in order to maintain backward compatibility, this should also be a new command.
b. Program
   No changes are required other than expanding the column address to account for the larger page buffer.
c. Multi-plane commands
   Modern NAND flash memory uses at least two planes on the same die, which also results in one page buffer per plane. In the specific case of dual plane NAND flash this means two page buffers per die that are addressed individually on a per-plane basis. The extensions for multi-plane commands can be easily done by expanding the read/program /copyback cases explained above.
d. Read/Program command variations like Read Cache, Program Cache.
   The extensions for these commands are basically the same as Read and Program.

2. New commands for page buffer manipulation
a. Replace
   Command format: {1^{st} command, source offset, destination offset, size, 2^{nd} command}
   Semantics: overwrite data starting at ‘destination offset’ with the data starting from source offset for the length of ‘size’
   Commands: 1 byte,
   Source offset, destination offset, size: 2 bytes
   Command encoding: TBD
b. Swap
   Command format: {1^{st} command, source offset, destination offset, size, 2^{nd} command}
   Semantics: swap two chunks of data with size of ‘size’ each starting at source and destination offset.
   Commands: 1 byte,
   Source offset, destination offset, size: 2 bytes

Command encoding may vary depending on the specific NAND flash IC used.

However, in order to maintain backward compatibility, this should also be a new command.

Examples are now given specifically with reference to the figures. It is noted, however, that these examples are nonlimiting and for illustrative purposes only, and other instructions that are functionally equivalent could be supplemented for those used here:

### 1) FIGS. 5, 6, and 7

Use the new read command. In the FIG. 7, in order to read C0 into S7:
Read: 1^{st} command -> Column Address: 0x0-> Raw address: 0x0-> Buffer offset: ⅞* Page buffer size+1-> xfer size: 0x ⅛* page buffer size ->2^{nd} command.

Followed by reading C7 into S3.
Read: 1^{st} command -> Column Address: ¾* page size+1-> Raw address: 0x4-> Buffer offset: ⅜* Page buffer size+1-> xfer size: 0x⅛* page buffer size ->2^{nd} command

### 2) FIG. 8, 8a

Use all of new commands. In order to achieve what's in FIG. 8a, the overall sequence should look like the following.
   Read C0 & C1 to page buffer S0, S1
   -> Read C5 & C7 to page buffer S5 & S7
   -> shift data in the page buffer to form a packed page size buffer
   -> write to page 9.
Accordingly, the command sequence would be:
   Read: 1^{st} command
   -> Column address: 0x0
   -> raw address: 0x0-> Buffer offset: 0x0
   -> xfer size: Page size
   ->2^{nd} command
   Read: 1^{st} command
   -> Column address: 0x0
   -> raw address: 0x4
   -> Buffer offset: page size
   -> xfer size: page size
   Replace command: 1^{st} command
   -> source offset: ⅝* page buffer size
   -> destination offset: 2/8* page buffer size
   -> size: ⅛* page buffer size
   ->2^{nd} command (to move C5 in S5 to S2 position)
   Replace command: 1^{st} command
   -> source offset: ⅞* page buffer size
   -> destination offset: ⅜* page buffer size
   -> size: ⅛* page buffer size
   ->2^{nd} command (to move C7 in S7 to S3 position)
   Program: 1^{st} command
   -> Column address 0x0
   -> raw address: 0x9
   ->2^{nd} command
   ->3^{rd} command
      A small modification of the above sequence could also be used as indicated in the following example:
Read: 1^{st} command
-> Column address: 0x0
-> raw address: 0x0
-> Buffer offset: 0x0
-> xfer size: Page size
->2^{nd} command
Read: 1^{st} command
-> Column address: 0x0
-> raw address: 0x4
-> Buffer offset: 2/8* page buffer size
-> xfer size: page size (Read the page 4 into page buffer starting at S2 position)
Replace command: 1^{st} command
-> source offset: 4/8* page buffer size
-> destination offset: ⅜* page buffer size
-> size: ⅛* page buffer size
->2^{nd} command (to move C7 in S4 to S3 position)
Program: 1^{st} command
-> Column address 0x0
-> raw address: 0x9
->2^{nd} command
->3^{rd} command
   The “swap” command can be an optional command, depending on the specific implementation of the invention.

The implementations of new NAND flash instructions as discussed above in exemplary form, in combination with a segmented page buffer that is larger than a single page, results in a NAND flash device with built-in intelligent features and reduces the workload on the controller in housekeeping operations such as garbage collection and space reclamation. It is further noted that instead of a strict “cluster” or “sector”-based segmentation, it may be advantageous to define the offset on a byte basis in order to account for variable space requirements of the different forms and levels of error correction used.

While certain components are shown and described for non-volatile memory-based mass storage devices of this invention, it is foreseeable that functionally-equivalent components could be used or subsequently developed to perform the intended functions of the disclosed components. Therefore, while the invention has been described in terms of a preferred embodiment, it is apparent that other forms could be adopted by one skilled in the art, and the scope of the invention is to be limited only by the following claims.

1. A non-volatile solid-state memory device used in a mass storage device operatively connected to a host computer system having an operating system and a file system, the memory device comprising:
memory cells organized in pages that are characterized by a page size and organized into memory blocks for storing data; and
a page buffer partitioned into segments corresponding to a cluster size of the file system of the host computer system, the size of the page buffer being larger than the page size of any of the pages of the memory device.

2. A method of operating the non-volatile solid-state memory device of claim 1, the method comprising:
reading a first page of the pages into the page buffer, the first page containing a valid cluster and an invalid cluster and the invalid cluster is marked for purging;
reading a second page of the pages into the page buffer, the second page containing a valid cluster and an invalid cluster and the invalid cluster is marked for purging;
storing the clusters of the first and second pages in the segments of the page buffer; and
logically re-ordering the segments containing the valid clusters and writing the segments containing the valid clusters back to a third page of the pages.

3. The method of claim 2, wherein the third page is in the same or in a different block than the first and the second page.

4. The method of claim 3 wherein, if the combined size of a number of the valid clusters to be written to the third page exceeds the page size, some of the clusters are temporarily held in the page buffer, combined with valid clusters from a fourth page of the pages, and stored in a fifth page of the pages.

5. A solid state drive operatively connected to a host computer system having an operating system and a file system that uses allocation units, the solid state drive comprising:
a NAND flash memory device having NAND flash cells organized into pages that are characterized by a page size and organized into memory blocks for storing data, wherein each page is capable of storing at least two file system allocation units;
a controller through which data pass when being written to and read from the memory device; and
a page buffer in communication with the pages, the page buffer having a size of at least two pages and being divided into at least four segments, wherein each segment is of sufficient size to store one of the allocation units of the file system.

6. The solid state drive of claim 5, wherein the page buffer segments are aligned with the allocation units of the file system and ECC information thereof.

7. The solid state drive of claim 6, wherein the page buffer is n-way set associative and wherein n is the number of segments that can be stored in the page buffer.

8. A method of operating the solid state drive of claim 7, the method comprising:
loading data from two of the pages into the page buffer;
storing each allocation unit in one of the segments of the page buffer;
purging data in segments corresponding to the allocation units marked as invalid;
logically recombining data in segments corresponding to allocation units marked as valid and writing the recombined data back to at least one page of the NAND flash memory device without involving the controller.

9. The method of claim 8, wherein if the number of valid allocation units held in the segment of the page buffer exceeds the number of allocation units that can be stored in one of the pages, the number of valid allocation units matching the page size is written to the page and additional segments containing valid allocation units are kept in the page buffer.

10. The method of claim 9, wherein the valid allocation units in the page buffer are combined with valid allocation units from an additional page read into the page buffer, and wherein segments originating from different pages and containing valid allocation units matching the number of allocation units that can be stored in a page are re-ordered to form a contiguous set of data matching the capacity of a page and then written to a free page.

11. A method of reclaiming free space in a NAND flash memory device of a solid state drive operatively connected to a host computer system, the memory device comprising a volatile memory-based page buffer and NAND flash cells organized into pages that are characterized by a page size and organized into memory blocks for storing data wherein the page buffer is at least twice the size of any of the pages of the memory device and is divided into segments, the method comprising:
reading the contents of a first page into the page buffer, the first page containing valid and invalid file system allocation units that are stored in segments of the page buffer;
reading the contents of a second page into the page buffer, the second page containing valid and invalid file system allocation units that are stored in segments of the page buffer;
recombining segments containing valid allocation units to a logically coherent data structure matching the size of a page; and
writing the logically coherent data structure to a free third page.

12. The method of claim 11 wherein, if the combined size of the valid file system allocation units read into the segments of the page buffer exceeds the size of one of the pages, only some of the segments with the valid allocation units are written to the third page and the rest are kept for subsequent combination with valid allocation units from a fourth page and then written to a fifth page.

13. The method of claim 12, wherein the page buffer is n-way set associative and wherein n equals the number of segments in the page buffer.

14. The method of claim 13 wherein, after a timeout, the segments of the page buffer containing the valid file system allocation units are written to a page even if the combined size of valid allocation units is lower than the size of a page.

15. A method for efficiently writing from a host computer system to a solid state drive having NAND flash memory devices as non-volatile storage medium, each of the memory devices having NAND flash memory cells organized in pages that are characterized by a page size and organized into memory blocks for storing data, each of the memory devices further having a page buffer organized into segments, the page buffer being at least twice the size of any of the memory pages, the method comprising:
the host computer system writing a file system allocation unit to the solid state drive;
committing the allocation unit to at least one of the memory devices;
holding the allocation unit in a segment of the page buffer of the memory device;
adding additional allocation units to additional segments of the page buffer;
combining a plurality of segments having allocation units to a logically coherent data structure; and
writing the logically coherent data structure to a free page of the memory device, wherein the additional allocation units may originate from the host computer system or from partially valid pages of the same memory device.

16. A NAND flash memory device of a solid state drive adapted for use with a host computer system having a file system with an allocation unit size, the NAND flash memory device having cells organized into blocks and pages for storing data and a page buffer of at least twice the size of any one of the pages, wherein the memory device is adapted so that during initial installation of the solid state drive in the host computer system the page buffer is programmed to have at least two segments, each segment has a size corresponding to the allocation size of the file system used by the host computer system, and the number of segments is the ratio of the page buffer size and the segment size.

17. The NAND flash memory device of claim 16, wherein the segments are n-way set associative with n being the number of segments.
